(19) United States
(12) Patent Application Publication
(10) Pub. No.: US 2012/0059647 A1
(43) Pub. Date: Mar. 8, 2012

(54) Touchless Texting Exercise

(75) Inventor: Amer Hammoud, Ottawa (CA)

(73) Assignee: International Business Machines Corporation, Armonk, NY (US)

(21) Appl. No.: 12/877,730

(22) Filed: Sep. 8, 2010

(51) Int. Cl. G06F 3/033; G06F 17/27

(52) U.S. Cl. 704/9; 345/158; 704/E11.001

(57) ABSTRACT

A method, system, and computer program product are provided for touchless texting that enhances user activity. A plurality of graphical images are displayed on a computer display. An exercise motion is detected using a camera, and the motion is resolved to a selected graphical image from the plurality of graphical images. The selected graphical image is entered into an application.

### FIELD OF THE INVENTION

The invention relates to the field of computer interfaces and more particularly to a a touchless texting method that increases user activity.

### BACKGROUND

The advent of technology and wide diffusion of the computer has created millions of jobs of a sedentary nature characterized by lack of activity. While the pursuit of higher efficiencies and increased productivity has always been the main driving force of technology, compromises to the physical well-being of sedentary workers and potential loss of productivity in the long run provide a new driving factor for developing and implementing technologies that cater to the physical needs of workers and not just the process being performed.

### SUMMARY

According to various embodiments of the present invention a method, system and computer program product for touchless texting that enhances user activity are provided.

According to one embodiment a method for touchless texting that enhances user activity is provided. The method comprises displaying on a computer display a plurality of graphical images in an arrangement corresponding to an exercise motion; detecting an exercise motion and translating the motion to a selected graphical image from the plurality of graphical images; and entering the selected graphical image into an application. According to one embodiment the graphical images are letters and the application is a text communication application.

Optionally, the method for touchless texting that enhances user activity comprises a predictive word completion method. Possible words are predicted based on the letters currently entered. A list of predicted words is displayed on the computer display in an arrangement corresponding to an exercise motion. Then, an exercise motion is detected and the motion is resolved to a selected word from the list of words, and the selected word is entered into the application. According to one embodiment, the list of predicted words is displayed if the words on the list do not exceed a threshold number of words and letters are displayed if the number of words on the list of predicted words exceeds the threshold number. According to one embodiment, the number of words on list of predicted words may be exceed the number of words that can be presented on the screen at one time. In this embodiment one or more scroll buttons may be provided to scroll up or down the list of predicted words.

According to one embodiment, the step of detecting an exercise motion and translating the motion to a selected graphical image from the plurality of graphical images comprises: detecting an exercise motion and analyzing whether the motion can be resolved to a single graphical image; in response to determining that the exercise motion can not be resolved to a single graphical image: resolving the exercise motion to a subset of the plurality of graphical images; displaying on a computer display the subset of the plurality of graphical images in an arrangement corresponding to an exercise motion; and repeating the detecting, resolving, and displaying steps until the exercise motion can be resolved to a single graphical image.

According to one embodiment, following entry of a selected graphical image into the application, the graphical images are arranged to correspond to a different exercise motions during selection of a subsequent graphical image.

According to one embodiment, the step of translating the motion to a selected graphical image from the plurality of graphical images comprises: determining a location of the exercise motion; comparing the location of the exercise motion with the positions of the graphical images in the plurality of graphical images; and selecting at least one graphical image whose location matches the location of the exercise motion.

According to one embodiment of the present invention, a system for touchless texting that enhances user activity is provided. The system comprises: a processor; a camera, operably connected with the processor and configured to detect an exercise motion; a display operably connected with the processor; a memory, operably connected with the processor and having stored thereon a program of instruction executable by the processor to: display a plurality of graphical images on the display in a configuration corresponding to an exercise motion; in response to the camera detecting the exercise motion, resolving the motion to a selected graphical image from the plurality of graphical images; and entering the selected graphical image into an application. According to one embodiment the processor is a microprocessor in a personal computer. According to one embodiment the camera is a webcam.

According to one embodiment of the present invention, a computer program product is provided. The computer program product comprises a computer readable storage medium having encoded thereon a computer-executable program of instructions. The computer executable program of instructions comprises: instructions for displaying on a computer display a plurality of graphical images in an arrangement corresponding to an exercise motion; instructions for detecting an exercise motion and translating the motion to a selected graphical image from the plurality of graphical images; and instructions for entering the selected graphical image into an application. According to one embodiment, the graphical images are letters and the application is a text communication application.

According to one embodiment, the computer program product further comprises: instructions for predicting possible words based on the letters currently entered; instructions for displaying on the computer display a list of the predicted words in an arrangement corresponding to an exercise motion; instructions for detecting an exercise motion and translating the motion to a selected word from the list of words; and instructions for entering the word to the application.

According to one embodiment, a computer program product is provided, wherein the instructions for displaying the list of predicted words: display the list of predicted words if the words on the list do not exceed a threshold number of words; and display letters if the words on the list of predicted words exceeds the threshold number.

According to one embodiment, a computer program product having instructions for detecting an exercise motion and translating the motion to a selected graphical image from the plurality of graphical images comprises: instructions for detecting an exercise motion and analyzing whether the motion can be resolved to a single graphical image; and instruction for, in response to determining that the exercise motion can not be resolved to a single graphical image: resolving the exercise motion to a subset of the plurality of graphical images; and displaying on a computer display the subset of the plurality of graphical images in an arrangement corresponding to an exercise motion; and instructions for repeating the detecting, resolving and displaying steps until the exercise motion can be resolved to a single graphical image.

According to one embodiment, a computer program product further comprises instructions for arranging the graphical images to correspond to a different exercise motions during selection of a subsequent graphical image following entry of a selected graphical image into the application.

According to one embodiment, a computer program product having instructions for translating the motion to a selected graphical image from the plurality of graphical images comprises: instructions for determining a location of the exercise motion; instructions for comparing the location of the exercise motion with the positions of the graphical images in the plurality of graphical images; and instructions for selecting at least one graphical image whose location matches the location of the exercise motion.

### BRIEF DESCRIPTION OF THE DRAWINGS

The features and advantages of the invention will be more clearly understood from the following detailed description of the preferred embodiments when read in connection with the accompanying drawing. Included in the drawing are the following figures:

FIG. 1 is block diagram of a system for touchless texting that enhances user activity according to an embodiment of the present invention;

FIG. 2 is a flow diagram for a method for touchless texting that enhances user activity according to an embodiment of the present invention; and

FIGS. 3 through 6 show various steps in the method of FIG. 2 viewed from inside the computer monitor.

### DETAILED DESCRIPTION

The present invention provides a method, apparatus and program product for touchless texting that enhances user activity.

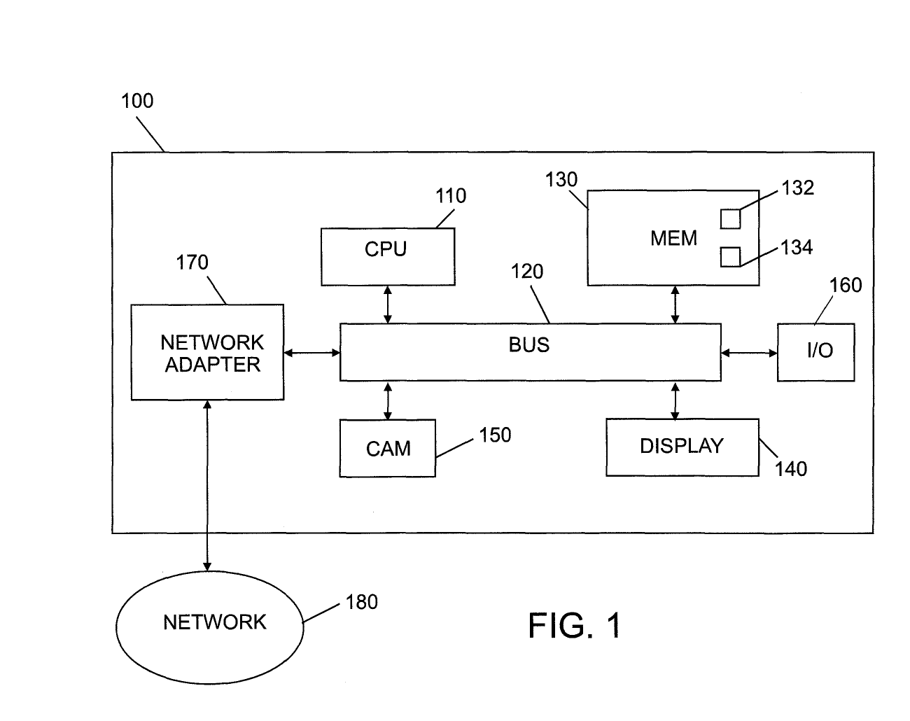

According to an embodiment of the present invention, and as shown in FIG. 1, a system 100 is provided which may comprise a personal computer or other computing apparatus. The system comprises a processor 110 which may include hardware, software, or a combination thereof. According to one embodiment, the processor 110 is one or more microprocessors.

The system also comprises a memory 130 that is operably connected with the processor 110. The memory 130 may comprise volatile memory such as Random Access Memory, or non-volatile memory such as a magnetic drive, an optical drive, a USB memory device, a disc, or the like. The memory 130 may be operably connected to the processor 110 by a data bus 120, or the like, such that electronic signals representing data, program steps, and the like may be transferred between the processor 110 and the memory 130.

A display 140 is also operably connected with the processor 110 to provide a graphical user interface. The display may be any monitor, television, or other device suitable for presenting graphical images to a computer user. The display 140 may be connected with the processor 110 through the bus 120.

A camera 150 is operably connected with the processor 110 and provides video of a user of the computer. The camera may be, for example, a web cam, or any other camera suitable for capturing user movements and transmitting images as digital signals. The camera 150 may be connected with the processor 110 through the system bus 120.

The computer 100 may further comprise a network adapter 170 and input/output devices 160. The network adapter 170 is connected with the processor, such as through the system bus 120. The network adapter 170 may be an Ethernet card, wireless internet connection, or the like. The network adapter 170 allows a computer user to communicate with other users and access applications on remote servers through a network 190 such as the Internet. Input/output devices may include, for example, a keyboard, a mouse, a printer, and the like for providing data to the computer and receiving data from the computer.

A program of instruction 132 is encoded on the memory 130. The program of instruction comprises computer executable program code in any suitable computer language. When the program of instruction is executed by the processor 110, it causes the computer to perform a method for touchless texting that enhances user activity. The program of instruction 132 may be integral to a communication application, such as a texting application, or it may be a separate application that enters data, such as letters and words into a separate texting application 134.

In an embodiment of the present invention, the program of instruction 132 is executed by the processor 110 to input letters and words into a text communication application 134. The processor 110 executes instructions that cause the computer display 140 to display letters 192 in an arrangement 190 corresponding to an exercise motion.

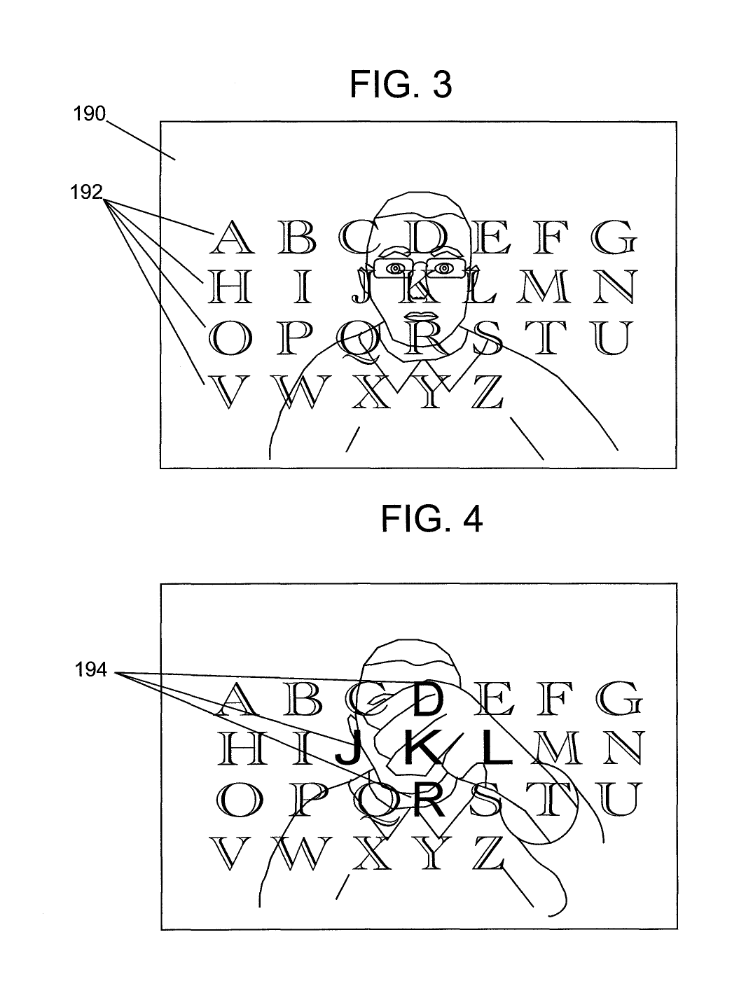

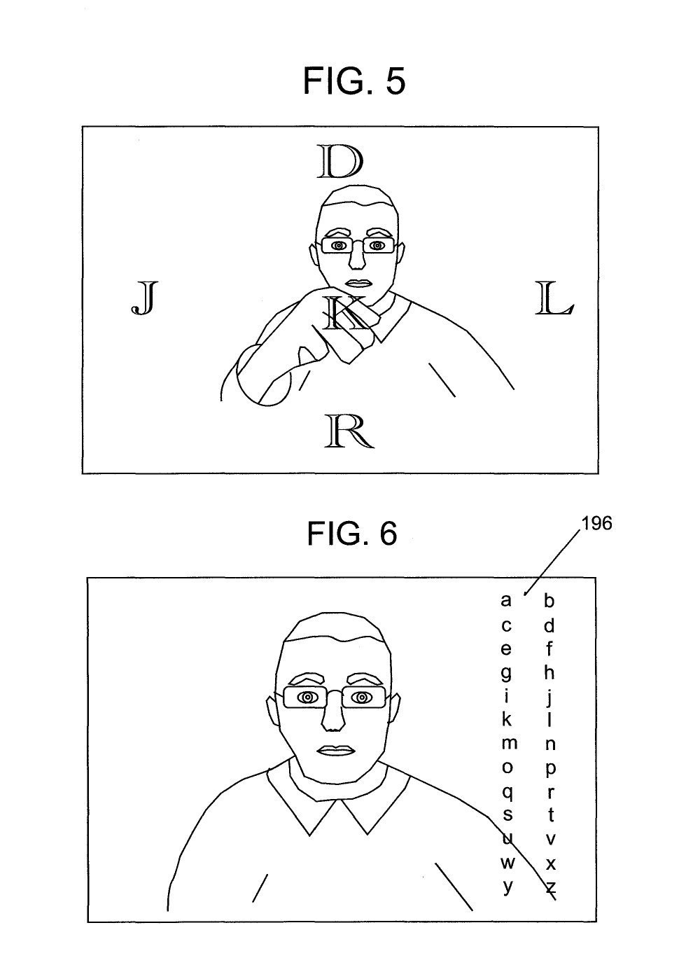

A computer user performs the exercise motion corresponding to a desired letter and the letter arrangement 190 on the computer display 140. For example, the computer user desires to enter the letter K in a text application, and the letters are arranged for a jab punch as shown in FIG. 3. The user jabs at the letter K on the computer display 140 as shown in FIG. 4.

The camera 150 detects the jab motion and attempts to resolve the motion to a single letter. The motion may be detected in a variety of ways. According to one embodiment, the camera estimates the position of a body part making the motion when the motion stops. According to various embodiments, the motion, or targeting action, may be determined to be completed: when a new motion commences, such as when a left jab is followed by a right jab; when it is determined that the motion or action is reversed, such as when a punch is retracted; or when an abrupt period of idleness ensues a motion, such as when a punch is stopped. The location of the body part used in the exercise motion is compared to the corresponding locations of the graphical symbols 192 displayed on the computer display 140. Thus, the motion is resolved to the letter or group of letters closest to the body part, such as a fist in a jab punch motion, when the computer user stops the motion. It should be appreciate that this method of resolving the motion allows for use of a two dimensional camera, reducing cost.

According to one embodiment, the program of instruction 132 determines whether or not the exercise motion can be resolved to a single letter. If the exercise motion can be resolved to a single letter, then the selected letter is entered into the text application 134.

If the exercise motion can not be resolved to a single letter, then the exercise motion is resolved to a group of letters comprising a subset of the letters arranged for selection. The determination of whether or not the exercise motion can be resolved to a single letter may be made using any suitable formula that provides adequate confidence for the letter selection. According to one embodiment, the determination is made that the exercise motion can be resolved to a single letter if only one letter corresponds to any part of the body part (e.g. fist) at the end of the exercise motion. Alternatively, the exercise motion may be resolved to the letter closest to the center of the location of the exercise motion (e.g., location of a fist for a jab punch) if the distance is below a threshold distance, such as one-fourth of the center-to-center spacing between letters in the present arrangement. Optionally, the trajectory leading to the end of the motion may be used to refine the targeting.

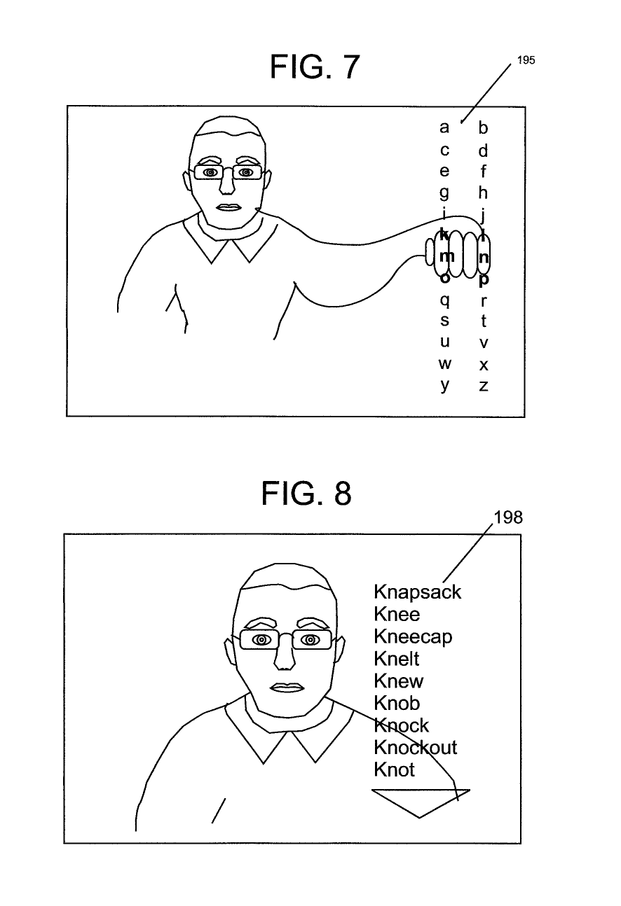

In the example illustrated in FIG. 4, the fist location corresponds, at least partially, to five letters: D, J, K, L, and R. Accordingly, the program of instruction in this example resolves the exercise motion to the selected subset of letters (D,J,K,L,R) 194. The letters in this subset are then arranged on the computer display 140 in an arrangement that provides greater spacing to refine the selection using another exercise motion. The selected subset of letters 194 may be enlarged and displayed over the entire screen of the computer monitor 140 as shown in FIG. 5. During an exercise motion, a tentative subset of letters may be highlighted as shown in FIG. 4 to aid the user in targeting a desired letter.

If a subset of letters 194 is displayed on the computer display 140, then the computer user performs another exercise motion to select a letter. For example, the computer user may perform a jab punch with his/her opposite hand, as shown in FIG. 5. The camera detects the second exercise motion and again attempts to resolve the location of the fist to a single letter. This process may be repeated until an exercise motion is resolved to a single letter. Optionally, the program of instructions may use cumulative values for a plurality of exercise motions, such as the cumulative percentage of coverage for each letter or the cumulative distances between the motions and a letter.

Once an exercise motion or plurality of exercise motions is resolved to a single letter, the selected letter is entered into the text application 134.

It should be understood that other motions are also contemplated, as well as other types of graphical symbols, such as numbers, pictures, or any other symbols that can be used for selecting between the items represented by the symbols. The graphical symbols 192 may also comprise control actions, such as: a carriage return; a switch or toggle function to switch between modes of exercises; scrolling up, down, left, or right in a list of items, such as words represented by the other graphical images; or any other function that can be performed on a keyboard. Moreover, the graphical symbols may be used in any application that requires selection of a graphical symbol from a plurality of graphical symbols.

It should also be noted that the graphical symbols may be transparent to allow a user to see an underlying application, such as a text communication application 134. To accomplish this transparency, the graphical symbols may be defined by outlines only or by shading, such as a highlighter function, or the like. Optionally, the user's image and motion captured by the camera 150 may be overlayed on the computer display 140. These images may also be presented transparently, such as a watermark, for example, to allow the underlying application to be seen on the computer display 140.

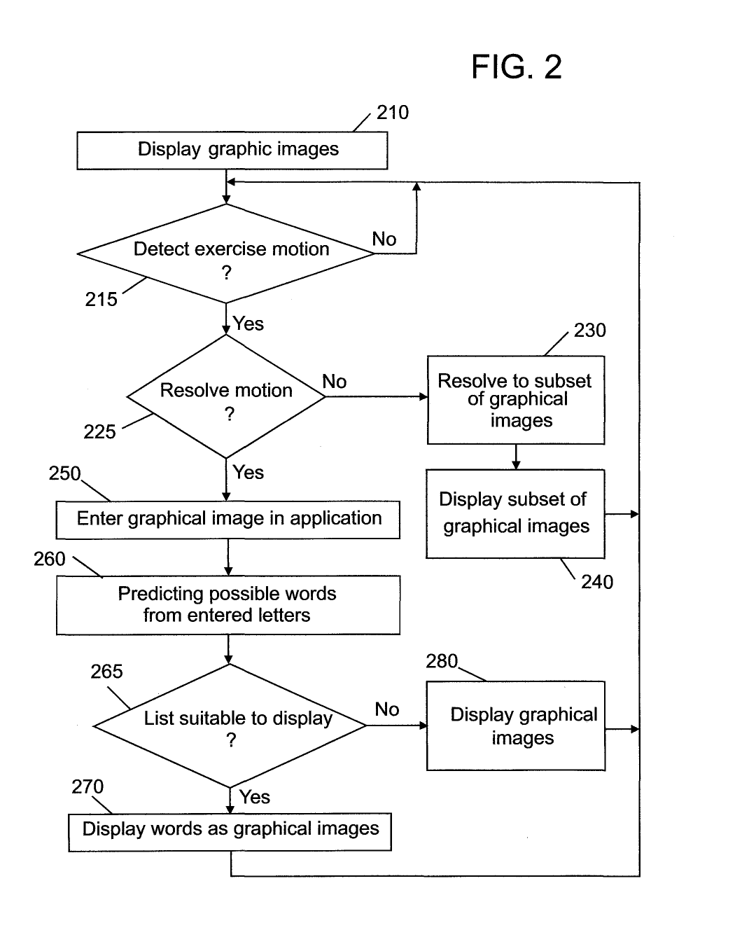

Referring now to FIG. 2, a flow diagram is provided for a method for touchless texting that enhances user activity. First, the processor 110 executing the program of instruction 132 causes the computer display 140 to display a set of graphical symbols on the computer display 140 in an arrangement corresponding to a planned exercise motion (step 210). For example, the alphabet is displayed arranged in alphabetical order in four rows on the computer display 140, as shown in FIG. 3.

The computer user performs an exercise motion, such as a jab punch at the desired letter, as shown in FIG. 4. The camera 150 is positioned to capture the location of the exercise motion, and the program of instruction 132 determines whether or not an exercise motion is detected (step 215). The determination may be made, for example, by estimating a location of a fist at the end of a jab punch. If no exercise motion is detected, then the camera continues to monitor the computer user, and the program of instruction 132 continues to analyze the camera output to determine whether or not an exercise motion is detected.

If an exercise motion is detected, then the program of instruction 132 determines whether or not the exercise motion can be resolved to a single letter (step 225). As described above, the determination may be made using any suitable formula that provides confidence that an accurate selection has been made.

If the exercise motion can not be resolved to a single letter, then the program of instruction 132 resolves the exercise motion to a subset of the letters that were displayed when the exercise motion was performed (step 230). The subset of letters 194 may be determined by including all letters which are at least partially located at the location of the user body part performing the motion (e.g. a fist for a jab punch). Alternatively, the subset of letters 194 may be determined to include all letters within a threshold distance of the estimated location of the user body part performing the motion. The subset of letters 198 may also be determined using any other method suitable for accurately determining a subset of letters that reflect the user selection.

The subset of letters 194 is displayed on the computer display 140 in an arrangement corresponding to a predetermined exercise move by the user (step 240), as shown in FIG. 5. The arrangement may be include only the subset of letters 194 presented with in an expanded arrangement to better distinguish the selected image. Also, the subset of letters 194 may be arranged for the same exercise motion or a different exercise motion. As an example, the first motion, shown in FIG. 4 is a left jab, while the second motion, shown in FIG. 5 is a right jab. A hook punch, an uppercut punch or other exercise motion may also be used with the graphical symbols 192 arranged accordingly.

The program of instruction 132 then monitors for an input from the camera 150 corresponding to a user exercise motion for selecting a letter (step 215).

If, at step 225, the program of instruction 132 determines that the exercise motion can be resolved to a single letter, then the letter is entered into the text application 134 (step 250).

In order to improve efficiency of the exercise texting method in an embodiment of the present invention, a predictive method may be applied. The predictive method may be integral with the program of instruction 132, integral with the texting application 134, or a stand-alone application. According to one embodiment the predictive method comprises compiling a list of possible words 198 based on the letters already entered for the present word (step 260). The list of words 198 is displayed on the computer display 140 for selection by the computer user using an exercise motion (step 280) as shown in FIG. 8.

When a predicted list of words will be displayed is controlled. If the list of possible words is too long, then displaying the word list would reduce efficiency. According to an embodiment of the present invention, a list of predicted words is not displayed until it can fit onto one screen of the computer monitor 140, for example. According to another embodiment, a graphical image 199 representing a scrolling function is included in the list of words 198. The program of instruction determines whether or not the list of predicted words is suitable for display (step 265) after each letter is added to the word. The determination is based on a predetermined threshold, such as number of possible words.

As with the graphical symbols for letter, the graphical symbols from the word list 198 may be iteratively reduced to a subset of words 197 and then to a single word, as shown in FIGS. 9 and 10.

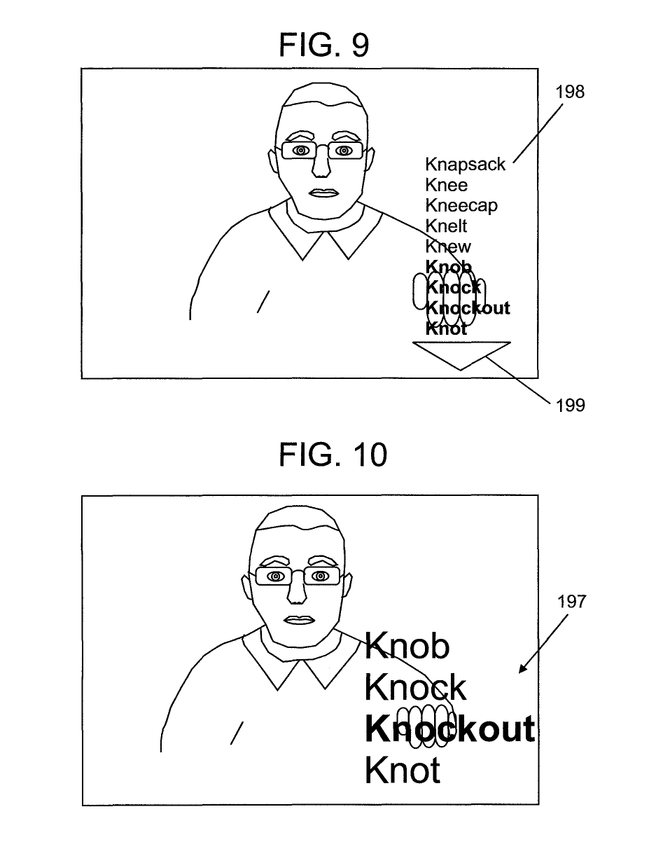

If the list of predicted words 198 is not suitable for display, then the program of instruction again displays letters for the computer user to select using an exercise motion (step 280) and monitors for an exercise motion (step 215). Optionally, as shown in FIG. 6, the graphical symbols representing letters may be arranged in an arrangement 195 corresponding to a different exercise motion, such as a left hook punch. A targeted letter may then be selected by targeting it with an appropriate exercise motion as shown in FIG. 7. It should be understood, that the second letter may also be selected by iteratively reducing the choices with subsequent exercise motions.

Another optional predictive method for improving words-per-minute (WPM) efficiency comprises presenting a subset of letters based on usage considerations, such as the place in a word and previous letters. For example, following a Q, the next letter would nearly always be a U. If the U is displayed in a larger font and separated from other choices, then the computer user may be able to select the letter U with a single exercise motion, reducing multiple motions and improving wpm efficiency.

According to an embodiment of the present invention, a method may be provided for switching between upper-case and lower-case letters. This may be accomplished, for example, by displaying a shift button on the computer display 140 with the letters for selection by the computer user. Additionally, other features may be presented on the computer display 140 for selection by the computer user, such as numbers, punctuation marks, and the like. Alternatively, a button may be displayed for choosing other menus of graphical symbols.

Optionally, after a letter or word is entered into the text application 134, letters may be displayed on the computer display 140 in an arrangement 196 corresponding to a different exercise motion, such as a hook punch, as shown in FIG. 6. It should also be noted that other exercise motions and corresponding arrangements of graphical symbols is contemplated within the scope of the present invention.

The invention can take the form of an entirely hardware embodiment, an entirely software embodiment or an embodiment containing both hardware and software elements. In an exemplary embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system or device. For the purposes of this description, a computer-usable or computer readable medium may be any apparatus that can contain or store the program for use by or in connection with the instruction execution system, apparatus, or device.

The foregoing method may be realized by a program product comprising a machine-readable medium having a machine-executable program of instructions, which when executed by a machine, such as a computer, performs the steps of the method. This program product may be stored on any of a variety of known machine-readable storage mediums, including but not limited to compact discs, floppy discs, USB memory devices, and the like.

The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk an optical disk. Current examples of optical disks include compact disk-read only memory (CD-ROM), compact disk-read/write (CD-R/W) and DVD.

The preceding description and accompanying drawing are intended to be illustrative and not limiting of the invention. The scope of the invention is intended to encompass equivalent variations and configurations to the full extent of the following claims.

What is claimed is:

1. A method for touchless texting that enhances user activity, comprising:
displaying on a computer display a plurality of graphical images in an arrangement corresponding to an exercise motion;
detecting an exercise motion and translating the motion to a selected graphical image from the plurality of graphical images; and
entering the selected graphical image into an application.

2. The method of claim 1, wherein said graphical images are letters and said application is a text communication application.

3. The method of claim 2, further comprising:
predicting possible words based on the letters currently entered;
displaying on the computer display a list of the predicted words in an arrangement corresponding to an exercise motion;
detecting an exercise motion and translating the motion to a selected word from the list of words; and
entering the word to the application.

4. The method of claim 3, wherein the list of predicted words is displayed if the words on the list do not exceed a threshold number of words and letters are displayed if the words on the list of predicted words exceeds the threshold number.

5. The method of claim 1 wherein the step of detecting an exercise motion and translating the motion to a selected graphical image from the plurality of graphical images comprises:
detecting an exercise motion and analyzing whether the motion can be resolved to a single graphical image;
in response to determining that the exercise motion can not be resolved to a single graphical image:
resolving the exercise motion to a subset of the plurality of graphical images; and
displaying on a computer display the subset of the plurality of graphical images in an arrangement corresponding to an exercise motion; and
repeating the detecting, resolving, and displaying steps until the exercise motion can be resolved to a single graphical image.

6. The method of claim 1, wherein following entry of a selected graphical image into the application, the graphical images are arranged to correspond to a different exercise motions during selection of a subsequent graphical image.

7. The method of claim 1, wherein the step of translating the motion to a selected graphical image from the plurality of graphical images comprises:
determining a location of the exercise motion;
comparing the location of the exercise motion with the positions of the graphical images in the plurality of graphical images; and
selecting at least one graphical image whose location matches the location of the exercise motion.

8. A system for touchless texting that enhances user activity, comprising:
a processor,
a camera, operably connected with the processor configured to detect an exercise motion;
a display operably connected with the processor,
a memory, operably connected with the processor, and having stored thereon a program of instruction executable by the processor to:
display a plurality of graphical images on the display in a configuration corresponding to an exercise motion;
in response to the camera detect the exercise motion, resolving the motion to a selected graphical image from the plurality of graphical images; and
enter the selected graphical image into an application.

9. The system of claim 8, wherein the processor is a microprocessor in a personal computer.

10. The system of claim 8, wherein the camera is a webcam.

11. A computer program product comprising a computer readable storage medium having encoded thereon a computer-executable program of instructions comprising:
instructions for displaying on a computer display a plurality of graphical images in an arrangement corresponding to an exercise motion;
instructions for detecting an exercise motion and translating the motion to a selected graphical image from the plurality of graphical images; and
instructions for entering the selected graphical image into an application.

12. The computer program product of claim 11, wherein said graphical images are letters and said application is a text communication application.

13. The computer program product of claim 12, further comprising:
instructions for predicting possible words based on the letters currently entered;
instructions for displaying on the computer display a list of the predicted words in an arrangement corresponding to an exercise motion;
instructions for detecting an exercise motion and translating the motion to a selected word from the list of words; and
instructions for entering the word to the application.

14. The computer program product of claim 13, wherein the instructions for displaying the list of predicted words:
display the list of predicted words if the words on the list do not exceed a threshold number of words; and
displays letters if the words on the list of predicted words exceeds the threshold number.

15. The computer program product of claim 11 wherein the instructions for detecting an exercise motion and translating the motion to a selected graphical image from the plurality of graphical images comprises:
instructions for detecting an exercise motion and analyzing whether the motion can be resolved to a single graphical image; and
instruction for, in response to determining that the exercise motion can not be resolved to a single graphical image:
resolving the exercise motion to a subset of the plurality of graphical images; and
displaying on a computer display the subset of the plurality of graphical images in an arrangement corresponding to an exercise motion; and
detecting an exercise motion and analyzing whether the motion can be resolved to a single graphical image.

16. The computer program product of claim 11, further comprising instructions for arranging the graphical images to correspond to a different exercise motions during selection of a subsequent graphical image following entry of a selected graphical image into the application.

17. The computer program product of claim 11, wherein the instructions for translating the motion to a selected graphical image from the plurality of graphical images comprise:
instructions for determining a location of the exercise motion;
instructions for comparing the location of the exercise motion with the positions of the graphical images in the plurality of graphical images; and
instructions for selecting at least one graphical image whose location matches the location of the exercise motion.
